(19) United States
(12) Patent Application Publication
(10) Pub. No.: US 2007/0094433 A1
(43) Pub. Date: Apr. 26, 2007

(54) Access priority order setting apparatus and method

(75) Inventors: Kunio Utsuki, Tachikawa-shi (JP); Kazuya Takada, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/512,094

(22) Filed: Aug. 30, 2006

(30) Foreign Application Priority Data
Oct. 20, 2005 (JP) 2005-305565

(51) Int. Cl. G06F 13/14

(52) U.S. Cl. 710/244; 710/104

(57) ABSTRACT

An apparatus and method, which can certainly meet access requests and have flexibility, are disclosed. The apparatus includes a unit to be accessed, a slot sequence signal controller which has a plurality of slots, and associates identification information of an access request unit to an arbitrary slot, a request signal holding unit which holds request signals of the access request units, an access request recognition unit which recognizes sequentially and cyclically using identification information in the plurality of slots whether or not the request signal of the access request unit corresponding to the current identification information is held in the request signal holding unit, and an access permission unit which permits access of the corresponding access request unit when the request signal is confirmed.

### CROSS-REFERENCE TO RELATED APPLICATIONS

This application is based upon and claims the benefit of priority from Japanese Patent Application No. 2005-305565, filed Oct. 20, 2005, the entire contents of which are incorporated herein by reference.

### BACKGROUND

1. Field

One embodiment of the invention relates to an access priority order setting apparatus and method, which set an access priority order when there are a plurality of access request units with respect to a unit to be accessed such as a memory, hard disk, or the like.

2. Description of the Related Art

When there are a plurality of access request units with respect to a unit to be accessed such as a memory, or the like, the access priority order must be set. If no access priority order is set, collision of data and commands occurs on a bus line.

As an apparatus for setting a priority order of this type, a technique described in patent reference 1 (Jpn. Pat. Appln. KOKAI Publication No. 2003-122586) is known. This technique is disclosed as a task scheduling apparatus based on the operating system of a computer. This technique adopts a round-robin scheme, and if there are a plurality of tasks with an identical priority level, these tasks are assigned to be executed in turn in short time periods indicated by their time slice values.

With the conventional access priority order setting method, a problem remains. That is, when the right of access to the unit to be accessed is assigned according to the priority order, an access request unit with a low priority order permanently cannot execute access in the worst case. Even when a given access request unit has the first priority order, if the number of access request units is large, too much time is required until it has a turn of access. Once the priority order is determined, the access request unit cannot change its waiting time until access execution.

With the round-robin scheme described in Jpn. Pat. Appln. KOKAI Publication No. 2003-122586, even in an access opportunity that has rolled around once, if there is another access request unit with an identical priority level, the control transits to a task of the other access request unit before its task is completed.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram showing the configuration according to an embodiment of the invention;

FIG. 2 is a block diagram showing an example of the detailed configuration of a priority order setting unit shown in FIG. 1;

FIG. 3 is an explanatory view showing another example of a slot sequence signal;

FIG. 4 is a flowchart showing an example of the operation of the apparatus according to the invention according to a priority order;

FIG. 5 is an explanatory diagram showing another example of a system to which the invention is applied;

FIG. 6 is an explanatory diagram showing an example of the configuration of a system controller shown in FIG. 5;

FIG. 7 is a flowchart showing an example of adjustment of the number of slots and the identification information assignment adjustment operation to slots; and

FIG. 8 shows a screen display example of the apparatus to which the invention is applied.

### DETAILED DESCRIPTION

Various embodiments according to the invention will be described hereinafter with reference to the accompanying drawings.

<Points Aimed at by Embodiment>

In this embodiment, even an access request unit with a low priority level of a large number of access request units can surely obtain access permission, while a priority level can be arbitrarily set for an access request unit that requires a high priority level. This embodiment provides an access priority order setting apparatus and method which are free from limitations on the number of access request units, and have a high degree of freedom.

This embodiment has a unit to be accessed, and a slot sequence signal controller. The slot sequence signal controller has a plurality of slots, and can associate identification information of an access request unit with an arbitrary slot. Also, this controller can associate a plurality of pieces of identification information with one slot. A request signal holding unit holds request signals of access request units. An access request recognition unit recognizes sequentially and cyclically using the identification information in the plurality of slots whether or not a request signal of an access request unit corresponding to the current identification information is held in the request signal holding unit. When the request signal of the access request unit corresponding to the identification information is recognized, an access permission unit permits the corresponding access request unit to access the unit to be accessed.

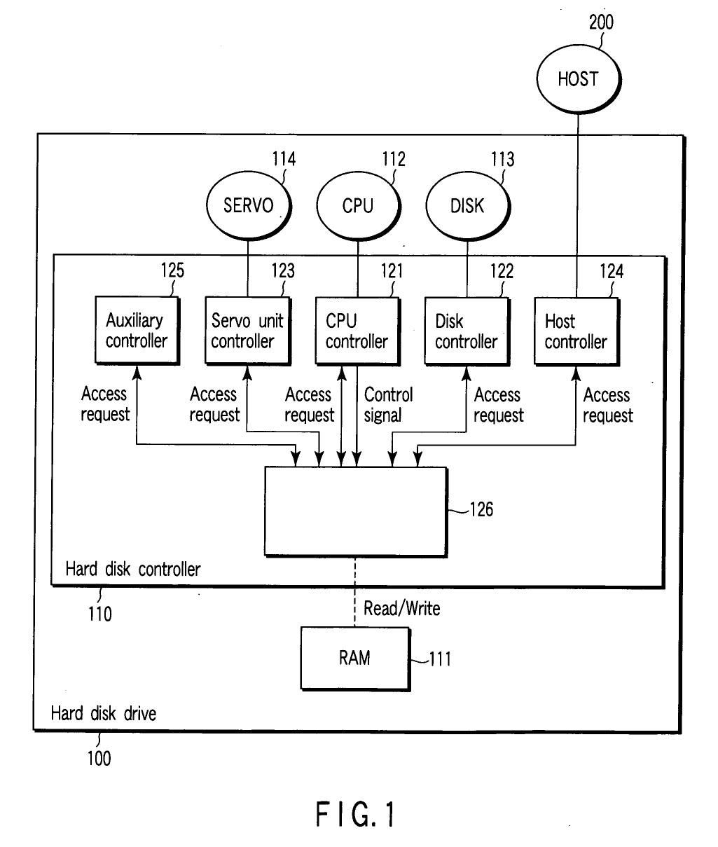

The embodiment of the invention will be described in detail hereinafter with reference to the accompanying drawings. FIG. 1 shows a basic configuration according to the embodiment of the invention. Reference numeral 100 denotes a hard disk drive (HDD) which includes a hard disk controller 110 and a random access memory (RAM) 111. Furthermore, the hard disk drive (HDD) 100 includes a central processing unit (CPU) 112 which controls the overall operation, a disk read and write unit 113, and a servo unit 114 which controls disk rotation. An external host computer 200 is connected to the hard disk drive 100.

The hard disk controller 110 includes a CPU controller 121, a disk controller 122, and a servo unit controller 123. Also, the hard disk controller 110 includes a host controller 124 which exchanges data and control data with the host computer 200. Furthermore, the hard disk controller 110 includes an auxiliary controller 125 which communicates with other units. Moreover, the hard disk controller 110 includes a priority order setting circuit 126.

The CPU controller 121 controls the operation timings or control data input and output timings of the CPU 112. The disk controller 122 controls the input and output timings of data to the disk read and write unit 113. The servo unit controller 123 controls the servo unit 114 to stably control disk rotation.

The CPU controller 121, disk controller 122, servo unit controller 123, host controller 124, and auxiliary controller 125 are access request units, and are connected to the priority order setting circuit 126. Upon reception of an access request from the access request unit, the priority order setting circuit 126 permits access to the memory 111 by a unique method to be described later.

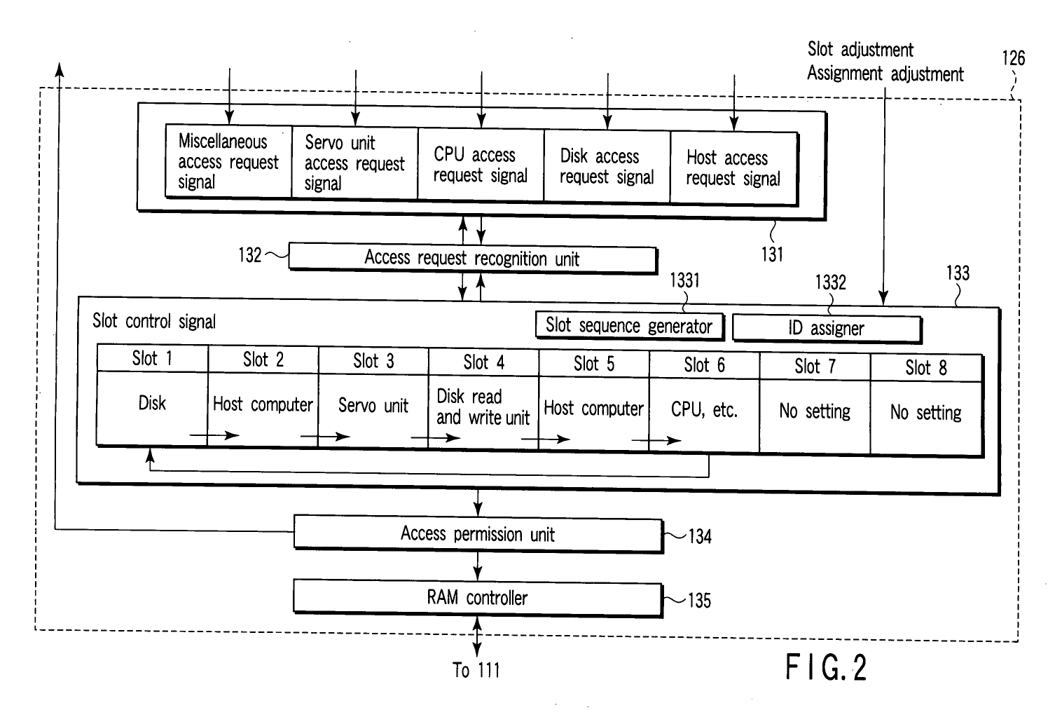

FIG. 2 shows an example of the internal configuration of the aforementioned priority order setting circuit 126. The priority order setting circuit 126 has a request signal holding unit 131. Also, the priority order setting circuit 126 has an access request recognition unit 132, slot signal controller 133, access permission unit 134, and RAM controller 135. The slot signal controller 133 has a slot sequence generator 1331 and ID assigner 1332.

When access request signals are output from the CPU controller 121, disk controller 122, servo unit controller 123, host controller 124, and auxiliary controller 125 as the access request units, the request signal holding unit 131 holds respective request signals. The request signals are held as flags for respective request units.

The slot signal controller 133 manages a slot sequence signal including slot 1, slot 2, . . . , slot 8. The respective slots of the slot sequence signal are assigned with, e.g., identification information of the disk controller 122, host controller 124, servo unit controller 123, CPU controller 121, disk read and write unit, and auxiliary controller 125 as the access request units. In the example of FIG. 2, the following assignment is made: slot 1—disk controller 122; slot 2—host controller 124; slot 3—servo unit controller 123; slot 4—disk read and write unit 113; slot 5—host controller; and slot 6—CPU controller 121 and auxiliary controller 125. Slots 7 and 8 are assigned with no information.

The access request recognition unit 132 recognizes a request signal of the access request unit corresponding to the current identification information sequentially and cyclically using the identification information in the plurality of slots 1 to 8. When the request signal is confirmed by the access request recognition unit 132, the access permission unit 134 permits the recognized access request unit to access the unit to be accessed (RAM 111) via the RAM controller 135. However, if no access request is set like in slots 7 and 8, these slots are skipped, and only valid slots are checked.

The host computer 200 requires RAM access in the following cases: a sequence control signal required for the hard disk drive 100 is to be saved in the RAM; data to be written from the host computer 200 to the hard disk is to be temporarily stored in the RAM 111; and the host computer 200 fetches data which is read from the hard disk and is temporarily stored in the RAM 111.

The disk read and write unit 113 requires RAM access in the following case: when data on the RAM 111 is to be written to the disk, data read from the disk is often stored in the RAM 111. The CPU 112 requires access to the RAM 111 in the following cases: a new program is to be fetched; and data whose arithmetic operation is underway is to be temporarily stored; and so forth. The servo unit 114 requires access to the RAM 111 in the following cases: a servo control signal which is calculated and stored in the RAM 111 is to be read; calculation elements required for servo control are to be temporarily stored in the RAM 111; and the stored calculation elements are to be read from the RAM 111.

In case of the aforementioned slot sequence signal, the access request units set in slots 1 to 8 are sequentially granted access permission. If there is an access request unit whose access is to be frequently executed, i.e., an access request unit with a high priority level, such access request unit with a high priority level can be set in two or three slots of slots 1 to 8. In the example shown in FIG. 2, since the host computer is set in slots 2 and 5, it has a high priority level.

In the above example, one access request unit corresponds to each slot of the slot signal. Also, a plurality of access request units can be associated with one slot. When the plurality of access request units can be associated with one slot, a priority order is also set for the plurality of access request unit in this slot. This priority order can be set arbitrarily, and the same setting method (slot scheme) as in FIG. 2 may be used or the priority order may be fixed in advance.

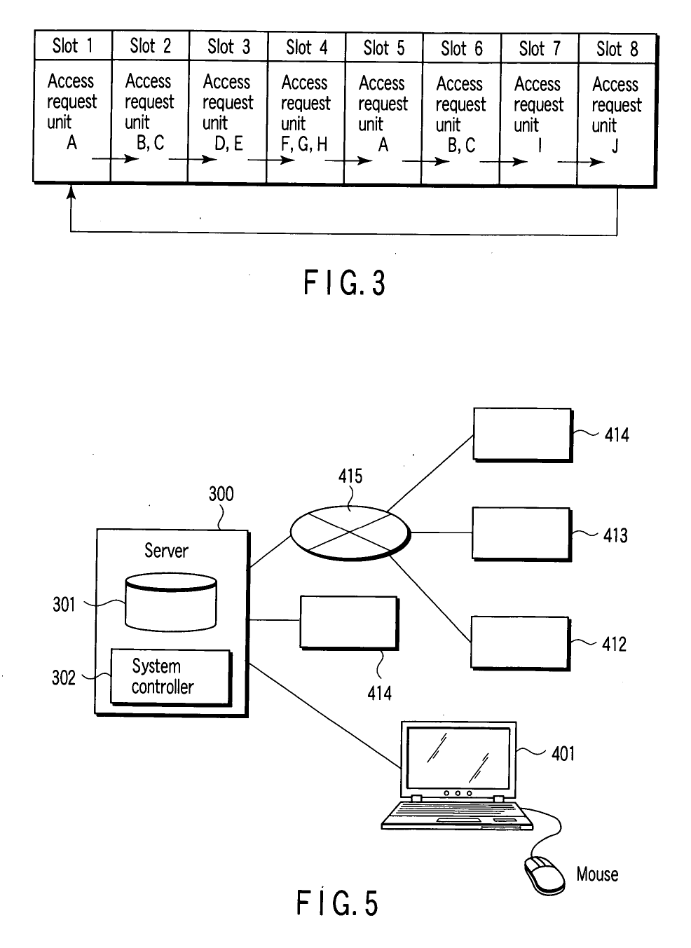

FIG. 3 shows another example of a slot sequence. In this example, a plurality of access request units are set in each of slots 2, 3, 4, and 6. Access request unit A has a high priority level since it is set in slots 1 and 5. Also, access request units B and C also have a high priority level since they are set in slots 2 and 6. If the number of accesses is large in one cycle of slots, the access waiting time of that access request unit is shortened.

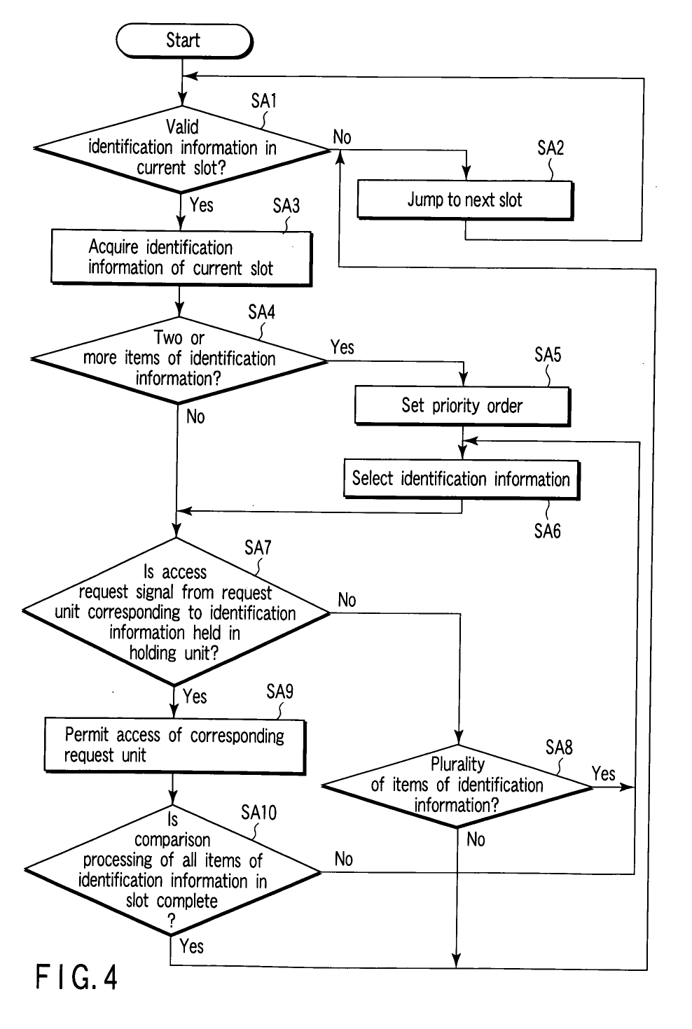

FIG. 4 is a flowchart showing the operation of the aforementioned embodiment. It is checked if the current slot stores (corresponds to) valid identification information of an access request unit (step SA1). If no valid identification information is stored, the control jumps to the next slot (step SA2). If the current slot stores valid identification information, that identification information is acquired (step SA3). If two or more pieces of identification information are stored in one slot (step SA4), a priority order is set (step SA5), and identification information with higher priority is selected (step SA6). If it is determined in step SA4 that only one identification information is stored, the flow advances to step SA7.

It is checked in step SA7 if an access request signal from the request unit corresponding to the identification information is held in the holding unit 131. An access request signal does not always exist. If no access request signal is held, and if it is determined in step SA8 that a plurality of pieces of identification information are stored in the slot, the flow returns to step SA6 to select the next identification information. If it is determined in step SA8 that the identification information is the last one, the flow returns to step SA2 to start the processing for the next slot.

If it is determined in step SA7 that the access request signal from the request unit corresponding to the identification information is held, the control permits the corresponding request unit to access the RAM 111. It is checked in step SA10 if comparison processing with access request units in the holding unit is complete for all pieces of identification information in the slot. If the comparison processing is complete, the flow returns to step SA2.

The idea of the invention can be applied to various apparatuses. FIG. 5 shows an example in which the invention is applied to a server 300. Referring to FIG. 5, the server 300 includes a hard disk drive 301 and system controller 302. A main computer 401 is connected to the server 300 and can control it. Also, a terminal 411 which issues an access request to the server 300 is connected to the server 300. Furthermore, a large number of terminals 412, 413, and 414 are connected via a network 415.

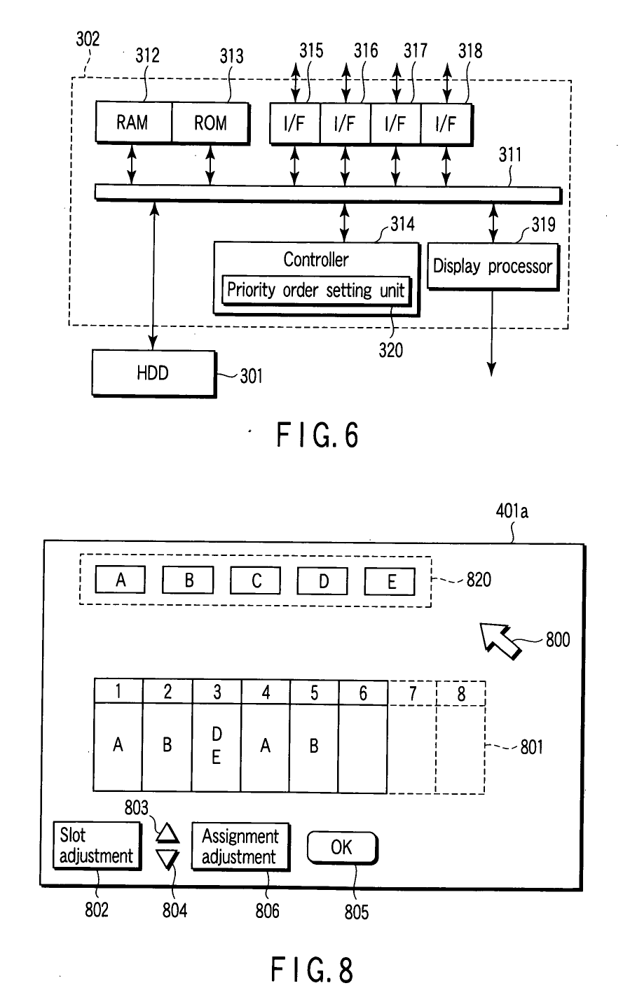

FIG. 6 shows details of the system controller 302 in the server 300. In the system controller 302, a controller 314 is connected to a bus 311. Also, a RAM 312, ROM 313, and interfaces 315 to 318 are connected to the bus 311. Furthermore, a display processor 319 is connected to the bus, and can output a display signal to the main computer 401. Display data, e.g., menu image data, icon image data, basic data of graphic interfaces, and the like are stored in the ROM 313. Also, moving image data can be fetched from an external terminal via an interface.

The controller 314 incorporates a priority order setting unit 320 as principal part of the invention. The priority order setting unit 320 manages the priority order of external access requests to the hard disk drive 301.

The priority order setting unit 320 can adjust the number of slots and can change assignment (priority order setting) of access request units to slots, as described above. An example of the processing sequence for implementing adjustment of the number of slots and assignment adjustment will be described below using FIG. 7.

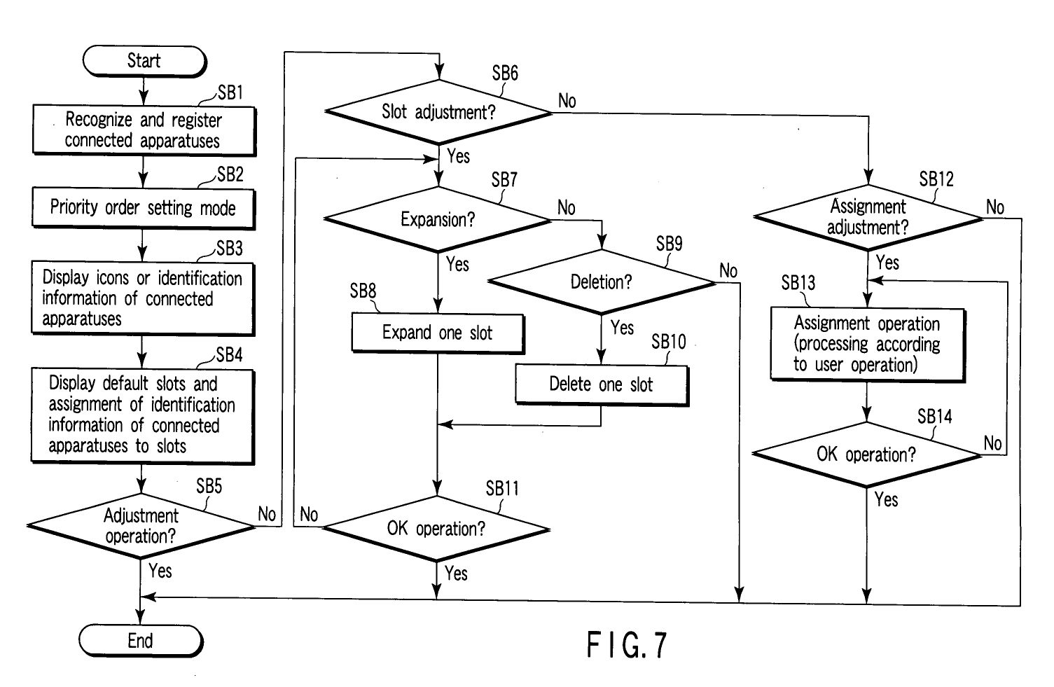

In FIG. 7, assume that identification information of each of connected apparatuses (access request units) connected to the server 300 is registered in a memory. If no adjustment is required, the priority order setting unit 320 automatically sets the access request priority order of the connected apparatuses (steps SB1 and SB2). When the user presses a priority order confirmation button on a menu screen, the priority order of the connected apparatuses is displayed on the screen of the main computer 401. For example, identification information A, B, C, . . . are displayed on a registration column 820 of connected apparatuses, and a slot sequence signal 801 is displayed, thus displaying the assigned state of identification information, as shown in FIG. 8.

For example, when the user clicks a slot adjustment button 802 using a cursor 800 to perform a slot adjustment operation, the control enters a slot adjustment mode (steps SB5 and SB6). A slot can be expanded or deleted by clicking, e.g., a button 803 or 804 (steps SB7 to SB10). After a required number of slots are obtained, the user presses an OK button 805, thus ending the setting. If the user presses an assignment adjustment button 806 to perform assignment adjustment (step SB12), the control enters an assignment adjustment mode. At this time, when the user clicks desired identification information in the registration column 820 using the cursor 800, and then performs the second clicking at a desired slot position, the desired identification information is registered at this slot position. Conversely, if the user wants to delete identification information from a given slot, he or she points that identification information with the cursor and then performs double-clicking, thus deleting the information.

Note that the invention is not limited to the embodiments intact, and it can be embodied by modifying required constituent elements without departing from the scope of the invention when it is practiced. Also, various inventions can be formed by appropriately combining a plurality of required constituent elements disclosed in the respective embodiments. For example, some required constituent elements may be omitted from all required constituent elements disclosed in the respective embodiments. Furthermore, required constituent elements of different embodiments may be appropriately combined.

According to the above embodiment, even an access request unit with a low priority level of a large number of access request units can surely obtain access permission, and a priority level can be arbitrarily set by assigning identification information of an access request unit that requires a high priority level in a plurality of slots. The number of slots can be easily expanded, and the number of access request units is not limited.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An access priority order setting apparatus comprising:
a unit to be accessed;
a slot sequence signal controller configured to have a plurality of slots, to associate identification information of an access request unit with an arbitrary slot, and to be able to associate a plurality of pieces of identification information with one slot;
a request signal holding unit configured to hold a request signal of the access request unit;
an access request recognition unit configured to recognize sequentially and cyclically using identification information in the plurality of slots whether or not a request signal of an access request unit corresponding to the current identification information is held in the request signal holding unit; and
an access permission unit configured to permit the corresponding access request unit to access the unit to be accessed when the request signal of the access request unit corresponding to the identification information is confirmed.

2. The apparatus according to claim 1, wherein the slot sequence signal controller comprises:
a slot sequence generator configured to generate the slot sequence signal; and
an identification information assigner configured to assign identification information of the access request units to the plurality of slots.

3. The apparatus according to claim 1, wherein the slot sequence signal controller comprises:
a slot sequence generator configured to generate the slot sequence signal; and
an identification information assigner configured to assign identification information of the access request units to the plurality of slots, and
the slot sequence generator is configured to adjust the number of slots of the plurality of slots.

4. The apparatus according to claim 1, wherein the slot sequence signal controller comprises:
a slot sequence generator configured to generate the slot sequence signal; and
an identification information assigner configured to assign identification information of the access request units to the plurality of slots, and
the identification information assigner is configured to arbitrary change the identification information of the access request units assigned to the plurality of slots.

5. The apparatus according to claim 1, wherein when a plurality of pieces of identification information corresponding to a plurality of access request units are assigned to one of the plurality of slots, the access request recognition unit and the access permission unit set a state in which the plurality of access request units corresponding to the plurality of pieces of identification information access the unit to be accessed in turn.

6. The apparatus according to claim 1, wherein when the identification information is not set in a slot retrieved in the middle of retrieval which is sequentially and cyclically made for the plurality of slots of the slot sequence signal, the access request recognition unit and the access permission unit jump to retrieval of the next slot.

7. An access priority order setting method which receives access request signals from a plurality of access request units, sets a priority order of access requests, and sets access permission to a unit to be accessed,
comprising in a setting circuit:
associating identification information of an access request unit to an arbitrary slot of a slot sequence signal having a plurality of slots;
holding request signals of the access request units;
recognizing sequentially and cyclically using identification information in the plurality of slots whether or not a request signal of an access request unit corresponding to the current identification information is held; and
permitting the corresponding access request unit to access the unit to be accessed when the request signal of the access request unit corresponding to the identification information is confirmed.

8. The method according to claim 7, wherein a plurality of pieces of identification information are associated with one slot of the slot sequence signal.

9. The method according to claim 7, wherein the slot sequence signal is generated by a slot sequence generator which is configured to adjust the number of slots.

10. The method according to claim 7, wherein identification information of the access request unit is assigned by an identification information assigner which is configured to adjust assignment to the plurality of slots.
